(19) United States
(12) Patent Application Publication
(10) Pub. No.: US 2010/0149074 A1
(43) Pub. Date: Jun. 17, 2010

(54) Film filter and display apparatus having the same

(75) Inventors: Do-Hyuk Kwon, Suwon-si (KR); Sung-Yong Lee, Suwon-si (KR); Jae-Young Park, Suwon-si (KR)

Correspondence Address: ROBERT E. BUSHNELL & LAW FIRM, 2029 K STREET NW, SUITE 600, WASHINGTON, DC, 20006-1004, US

(73) Assignee: Samsung SDI Co., Ltd., Suwon-si (KR)

(21) Appl. No.: 12/591,936

(22) Filed: Dec. 4, 2009

(30) Foreign Application Priority Data
Dec. 12, 2008 (KR) 10-2008-0126378

(51) Int. Cl. G09G 3/00; G02B 5/20

(52) U.S. Cl. 345/32; 359/892; 359/359

(57) ABSTRACT

A film filter capable of protecting a display apparatus against external shock and a display apparatus including the same. The film filter includes a first layer including ribs and a plurality of openings partitioned off by the ribs and having first hardness and a second layer including a plurality of cells inserted into the openings and having second hardness lower than the first hardness.

### CLAIM OF PRIORITY

This application claims priority to and the benefit of Korean Patent Application No. 10-2008-0126378, filed on Dec. 12, 2008, in the Korean Intellectual Property Office, the entire content of which is incorporated herein by reference.

### BACKGROUND OF THE INVENTION

1. Field of the Invention

An aspect of the present invention relates to a film filter capable of protecting a display apparatus against external impact and a display apparatus having the same.

2. Description of the Related Art

A film filter used for a conventional display apparatus has various structures in accordance with the object thereof. In particular, each of most film filters used for a plasma display apparatus includes a functional layer that absorbs strong near infrared rays and electromagnetic waves generated by driving the plasma display apparatus and that reduces the reflection of external light. Such a film filter is made lighter and thinner than a glass filter and is more effective for improving a double image than the glass filter.

However, the film filter has lower ability of shielding or buffering external shock applied to the display apparatus than the glass filter so that the function and the external shape of the display apparatus to which the external shock is applied can deteriorate. Therefore, in the film filter, it is required to introduce a functional layer that can properly protect the display apparatus against the external shock.

In particular, as the display apparatus is gradually made larger and thinner, the thickness of a front surface glass substrate provided on the visible surface of the display apparatus is gradually reduced. Therefore, it is required to effectively protect the display apparatus against the external shock applied to the front surface.

The above information disclosed in this Related Art section is only for enhancement of understanding of the background of the invention and therefore it may contain information that does not form the prior art that is already known to a person of ordinary skill in the art.

### SUMMARY OF THE INVENTION

Accordingly, it is an aspect of the present invention to provide a film filter attached onto the front surface of a display apparatus to effectively absorb external impact.

In addition, it is another object of the present invention to provide a display apparatus capable of improving durability against external impact applied to the front surface of the display apparatus.

In order to achieve the foregoing and/or other objects of the present invention, according to an aspect of the present invention, there is provided a film filter, comprising a first layer including ribs and a plurality of openings partitioned off by the ribs and having first hardness and a second layer including a plurality of cells inserted into the openings and having second hardness lower than the first hardness.

The height of the ribs, the distance between adjacent ribs, and the width of the ribs are set so that external impact can be primarily absorbed and dispersed and can be transmitted to the second layer.

The first layer can have a condensation ratio of 5% to 30% in a reversible range. The hardness of the second layer can be lower than the hardness of the first layer by 23% to 45%. At least one surface of the side surface of the second layer can incline based on the thickness direction of the first layer.

The openings can be polygonal. One end of each of the openings can be closed by the first layer.

The film filter can further include a first interposing layer provided on one surface having a structure in which the second layer is inserted into the openings. The film filter can further comprise a second interposing layer provided on the other surface that faces the one surface having the structure in which the second layer is inserted into the openings.

The first interposing layer can be made of poly ethylene terephthalate or poly carbonate.

The first layer can be made of at least one selected from the group consisting of poly ethylene terephthalate, poly carbonate, ethylene vinyl acetate (EVA), and urethane based.

The first layer can be colored by a dye or a pigment.

The second layer can be made of at least one selected from the group consisting of a polymer containing ethylene vinyl acetate (EVA), a copolymer of styrene and ethylene (styrene ethylene butadiene styrene (SEBS)), silicon gel, and highly bridged polyurethane based.

The first layer can be made of ethylene vinyl acetate (EVA) containing vinyl acetate no more than 20 wt % and the second layer can be made of ethylene vinyl acetate (EVA) containing vinyl acetate no less than 40 wt %.

The first layer can be made of ethylene vinyl acetate (EVA) containing vinyl acetate no more than 20 wt % and the second layer can be made of silicon based.

The film filter can further include at least one functional layer for, shielding electromagnetic waves, near infrared rays, and neon light, for correcting colors, and for preventing reflection of external light.

According to another aspect of the present invention, there is provided a display apparatus, including a display panel and a film filter provided on one surface of the display panel.

The display panel can be one of a plasma display panel (PDP), an organic light emitting display (OLED) panel, and a liquid crystal display (LCD) panel.

According to the present invention, a relatively soft material and a relatively firm material are combined with each other to provide the film filter that can effectively absorb the external impact.

In addition, the above-described film filter is provided on the front surface so that it is possible to provide a display apparatus capable of improving durability against the external impact applied from the front surface.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view illustrating a film filter according to an embodiment of the present invention;

FIG. 2 is a cross sectional view taken along line II-II of the film filter of FIG. 1;

FIG. 3 is a sectional view illustrating a film filter according to another embodiment of the present invention;

FIG. 4 is a sectional view illustrating a film filter according to still another embodiment of the present invention;

FIGS. 5A and 5B are perspective views illustrating another structure of a film filter according to the present invention;

FIG. 6 is a sectional view illustrating another structure that can be applied to the film filter according to the present invention; and

FIGS. 7A and 7B are schematic sectional views of a display apparatus according to the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “connected to” another element, it can be directly connected to another element or be indirectly connected to another element with one or more intervening elements interposed therebetween. Hereinafter, like reference numerals refer to like elements.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the principles for the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

Embodiments of the present invention now will be described more fully with reference to the accompanying drawings so that this disclosure will be thorough and complete, and will fully convey the concept of the invention to those skilled in the art.

In the following description, “transparent” means that an element has transmittance by which the element can be commonly considered to be transparent in the art as well as that the object is completely transparent. It will also be understood that when a layer is referred to as being on another layer or substrate, it can be directly on the other layer or substrate, or intervening layers may also be present. In the drawings, the thickness of layers and regions are exaggerated for clarity.

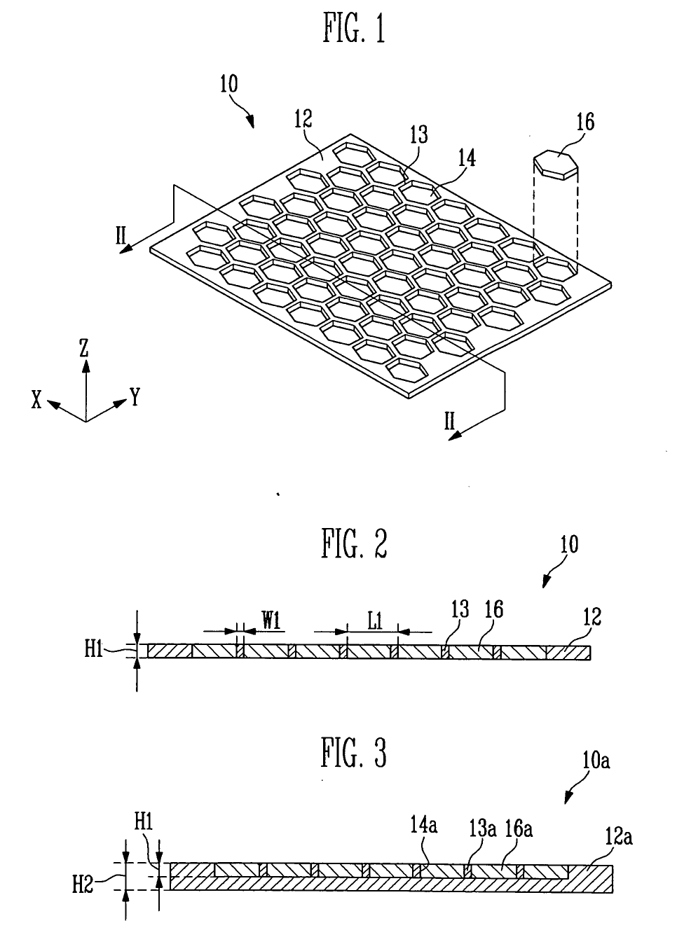

FIG. 1 is an exploded perspective view illustrating a film filter according to an embodiment of the present invention. FIG. 2 is a cross sectional view taken along line II-II of the film filter of FIG. 1.

Referring to FIGS. 1 and 2, a film filter 10 according to the present embodiment includes an impact absorbing layer. The impact absorbing layer includes a first layer 12 and a second layer 16 inserted into the first layer 12.

For reference, in FIG. 1, only one cell of the second layer 16 is illustrated. In FIG. 2, all of the cells of the second layer 16 are inserted into the openings of the first layer 12.

The first layer 12 includes ribs 13 and a plurality of openings 14 partitioned off by the ribs 13 and forms the basic structure of the impact absorbing layer. The first layer 12 is preferably formed of a material that requires a reversible reaction against external impact and that can be condensed or compressed about 5% to 30% in a range where the material is not permanently transformed by compressive force.

To be specific, in order to effectively absorb and disperse external impact energy, the height H1 of the ribs 13, the distance L1 between the adjacent ribs 13 in a direction, and the width W1 of the ribs 13 are designed in a predetermined ratio. For example, the height H1 of the ribs 13 is about 20 μm to 200 μm, the distance L1 between the ribs 13 is no less than 50 μm, and the width W1 of the ribs 13 is about 5 μm to 50 μm.

The external impact is controlled by the softness of the object to which the impact is applied. When the softness is maximized, an impact absorbing ratio can be reduced. In particular, the impact absorbing ratio of the film filter can be reduced when the softness of the film filter is maximized. Therefore, in the film filter according to the present invention, relatively soft and small cells absorb the external impact primarily absorbed and dispersed by a relatively firm object so that the external impact can be effectively reduced.

Ethylene vinyl acetate (EVA) and urethane based having low amounts of polyethylene terephthalate, polycarbonate, and vinylacetate can be used as the first layer 12. The material of the first layer 12 is not limited to the above-described materials but an opaque material that satisfies the physical characteristics required by the film filter 10 according to the present embodiment can be used.

In addition, in order to reduce the reflection of external light, the entire structure of the first layer 12 can reveal a specific color using a dye or a pigment as an additive. Carbon black can be used as the additive.

The second layer 16 includes a plurality of cells inserted into the openings 14 of the first layer 12. The second layer 16 protects the first layer 12 and primarily and secondarily absorbs the external impact energy.

The second layer 16 is preferably made of a material softer than the first layer 12, that is, a material having smaller hardness than the first layer 12 and having an optical characteristic in which reduction in light (brightness) generated by the display apparatus is low. The second layer 16 is preferably made of a transparent high molecular substance. A polymer containing ethylene vinyl acetate (EVA), a copolymer of styrene and ethylene (styrene ethylene butadiene styrene (SEBS)), silicon gel, and highly bridged polyurethane based can be used as the transparent high molecular substance.

The first layer 12 and the second layer 16 are made of a soft semi-hardened material and are formed so that the hardness of the first layer 12 is larger than the hardness of the second layer 16. For example, the hardness of the first layer 12 is larger than the hardness of the second layer 16 in a range from about 23% to 45%.

For example, the film filter 10 according to the present embodiment can be manufactured by polymerizing EVA containing vinylacetate no more than 20 wt % to form the first layer 12 in a predetermined pattern, which include the ribs 13 and the openings 14 and by polymerizing EVA containing vinylacetate no less than 40 wt % to fill the polymerized EVA in the openings 14 of the first layer 12. In this case, when the hardness of the first layer 12 is 90, the hardness (H) of the second layer 16 is about 70, which is because the hardness of polymerized EVA varies with the density of vinylacetate.

In another example, the film filter 10 according to the present embodiment can be manufactured by polymerizing EVA containing vinylacetate no more than 20 wt % to form the first layer 12 in a predetermined pattern, which includes the ribs 13 and the openings 14 and by filling silicon in the openings 14 of the first layer 12. In this case, when the hardness of the first layer 12 is 90, the hardness of the second layer 16 is no more than 50.

When the external impact is applied to one surface of the film filter 10, the external impact is first transmitted to the specific first region of the first layer 12 and/or the second layer 16. The impact transmitted to the first region is primarily absorbed and dispersed by the ribs 13 of the first layer 12 and the impact dispersed by the ribs 13 is dispersed and absorbed by the cells of the first layer 12 positioned in a second region around the first region. Therefore, the external impact energy can be effectively and absorbed and removed by the film filter 10.

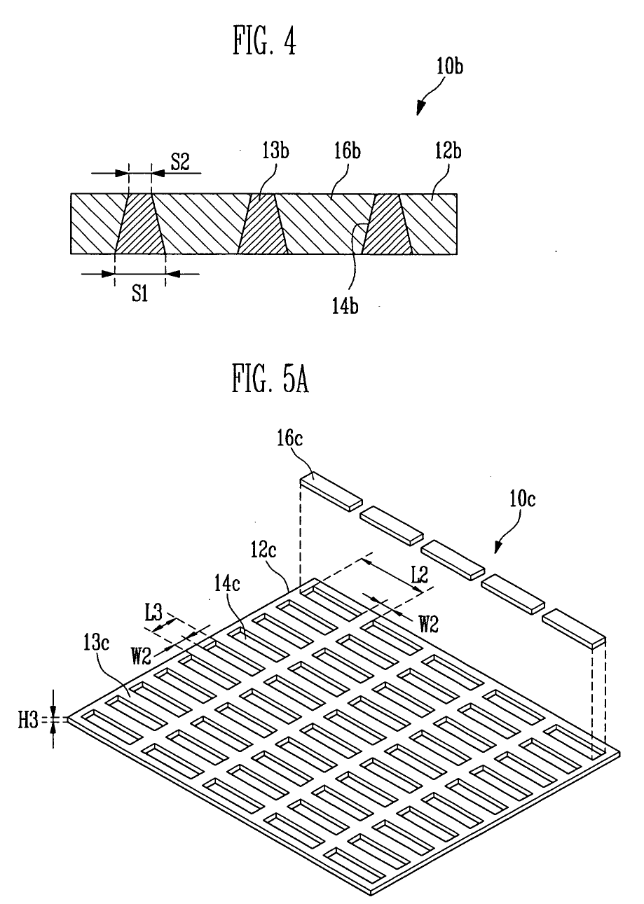

FIG. 3 is a sectional view of a film filter according to another embodiment of the present invention.

Referring to FIG. 3, a film filter 10a according to the present embodiment includes an impact absorbing layer. The impact absorbing layer includes a first layer 12a having ribs 13a and a plurality of openings 14a partitioned off by the ribs 13a and a second layer 16a having a plurality of cells inserted into the plurality of openings 14a of the first layer 12a. The thickness H2 of the first layer 12a is larger than the height H1 of the ribs 13a. In addition, the second layer 16a is surrounded by the first layer 12a excluding the one surface. That is, one end of each of the openings 14a is closed by the first layer 12a.

The film filter 10a according to the present embodiment is actually the same as the film filter 10 described with reference to FIGS. 1 and 2 excluding that the openings 14a of the first layer 12a do not penetrate the first layer 12a in a thickness direction but are formed in one surface of the first layer 12a in the form of grooves.

Since the second layer 16a does not penetrate the first layer 12a in the thickness direction, when the film filter 10a is additionally manufactured and is attached to the display apparatus, the film filter 10a can be easily dealt with.

FIG. 4 is a sectional view of a film filter according to still another embodiment of the present invention.

Referring to FIG. 4, a film filter 10b according to the present embodiment includes an impact absorbing layer. The impact absorbing layer includes a first layer 12b having ribs 13b and a plurality of openings 14b partitioned off by the ribs 13b and a second layer 16b having a plurality of cells inserted into the plurality of openings 14b of the first layer 12b. The size or the length (S1) of one end of each of the ribs 13b is larger than the size or the length (S2) of the other end of each of the ribs 13b. That is, the side surface of the second layer 16b has a structure in which at least one surface is inclined based on the thickness direction of the first layer 12b.

The film filter 10b according to the present embodiment is actually the same as the film filter 10 described with reference to FIGS. 1 and 2 excluding that the side surface of the rib 13b is inclined so that the cross section of the rib 13b is trapezoidal.

When the cross section of the rib 13b is trapezoidal, the external impact energy applied from one surface of the film filter 10b can be more effectively absorbed and dispersed by the ribs 13b.

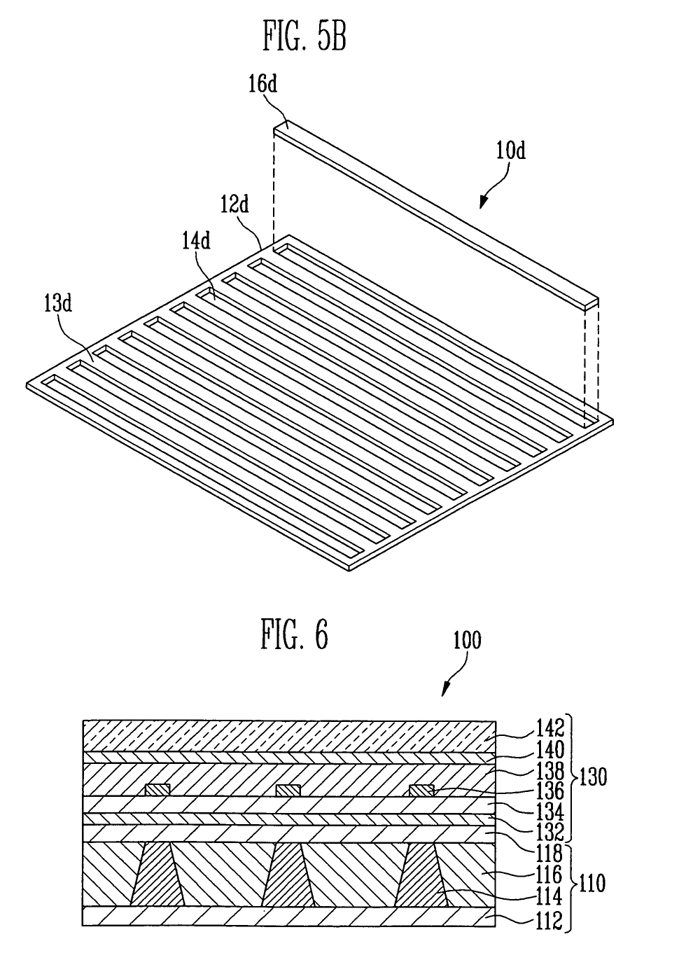

FIGS. 5A and 5B are perspective views illustrating another structure of a film filter according to the present invention.

As illustrated in FIG. 5A, a film filter 10c according to the present embodiment includes an impact preventing layer. The impact preventing layer includes a first layer 12c having ribs 13c and a plurality of openings 14c partitioned off by the ribs 13c and arranged in the form of lattices and a second layer 16c having a plurality of cells inserted into the openings 14c of the first layer 12c. The cells of the second layer 16c are rectangular parallelepiped.

The height H3 of the ribs 13c is about 20 μm to 200 μm and the distance L2 between the adjacent ribs 13c in the longitudinal direction of the openings 14c is no less than 50 μm. The distance L3 between the adjacent ribs 13c in the width direction of the openings 14c is about 50 μm to 300 μm and the width W2 of the ribs 13c is about 5 μm to 50 μm. The structure of the ribs 13c is designed in a predetermined ratio so that the ribs 13c are reversibly condensed about 5% to 30% against the external impact to absorb and disperse the external impact energy.

The structure of the film filter 10c can be combined with at least one of the structures of the film filters described with reference to FIGS. 3 and 4. The film filter 10c according to the present embodiment is actually the same as the film filter described with reference to FIG. 1 excluding the structure of the openings in the form of lattices.

In addition, as illustrated in FIG. 5B, a film filter 10d according to the present embodiment includes a first layer 12d having ribs 13d and a plurality of openings 14d partitioned off by the ribs 13d and a second layer 16d having a plurality of cells inserted into the openings 14d of the first layer 16d. The cells of the second layer 16d are in the form of stripe bars.

The ribs 13d of the film filter 10d are not latticed but opened. At this time, the cells of the second layer 16d inserted into the openings 14d are in the form of stripe bars.

In the combination of the relatively firm first layer 12d and the relatively soft second layer 16d, the impact absorbing ratio of the film filter 10d according to the present embodiment can be lower than the impact absorbing ratios of the above-described film filters since the number of cells of the second layer 16d is small. However, the film filter 10d can be applied in order to absorb the impact applied to the front surface of the display apparatus.

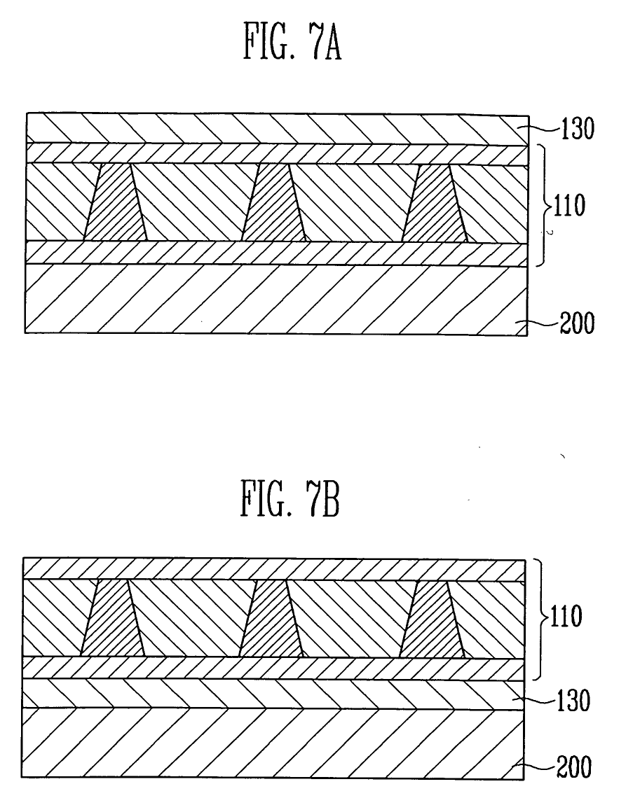

FIG. 6 is a sectional view illustrating another structure that can be applied to the film filter according to the present invention.

Referring to FIG. 6, a film filter 100 according to the present embodiment includes a first layer 114 having ribs and a plurality of openings partitioned off by the ribs and a second layer 116 having a plurality of cells inserted into the openings of the first layer 114. The first layer 114 and the second layer 116 according to the present embodiment form the impact preventing layer described above with reference to FIG. 4. On the other hand, the first layer and the second layer according to the present embodiment can have one or a combination of the structures of the embodiments described with reference to FIGS. 1 to 3 and 5A and 5B other than the structure illustrated in FIG. 4.

In addition, the film filter 100 can include a first interposing layer 112 and a second interposing layer 118 between which the first layer 114 and the second layer 116 are interposed and which are provided on both surfaces of the first layer 114 and the second layer 116 in order to improve the impact absorbing ability of the impact absorbing layer consisting of the first layer 114 and the second layer 116. The first interposing layer 112 and the second interposing layer 118 protect the first layer 114 and the second layer 116 and transmit the external impact energy to the first layer 114 and the second layer 116.

The first interposing layer 112 and the second interposing layer 118 are preferably made of a material in which a dynamic property and an optical property are well balanced as a film, which has a high mechanical strength and a small thermal contraction ratio, and which generates a small amount of oligomer. For example, the first interposing layer 112 and the second interposing layer 118 can be made of polyethyleneterephthalate (PET) and polycarbonate (PC). In order to apply the film filter according to the present embodiment to the display apparatus, the transmittance of the first interposing layer 112 and the second interposing layer 118 is preferably no less than 90%.

In the structure of the film filter 100 according to the present embodiment, the external impact applied to one surface of the film filter 100 is primarily absorbed and dispersed by the reversible condensation of the first interposing layer 112, the first layer 114, the second layer 116, and the second interposing layer 118 and is secondarily absorbed by the cells of the second layer 116 partitioned off by the ribs of the first layer 114. Hereinafter, for convenience sake, the structure of the first interposing layer 112, the first layer 114, the second layer 116, and the second interposing layer 118 is referred to as a impact absorbing structure 110.

In addition, the film filter 100 can include a functional layer 130 laminated on one surface of the impact absorbing structure 110. The functional layer 130 can include a conductive layer 136 for shielding electromagnetic waves, a chromatic layer 138 for shielding near infrared rays and neon light and for correcting colors, and a reflection preventing layer 142 for reducing the reflection of external light. The reflection preventing layer 142 is laminated on the chromatic layer 138 with a first adhesive layer 140 interposed.

Meanwhile, according to the present embodiment, the film filter 100 has a structure in which a second adhesive layer 132 is interposed and in which a third interposing layer 134 is laminated on the second interposing layer 118. The third interposing layer 134 operates as a supporting layer of the functional layer 130. However, the structure of the present invention is not limited to the above but can be realized so that the second interposing layer 118 is used instead of the third interposing layer 134. In this case, the second adhesive layer 132 and the third interposing layer 134 are omitted.

The conductive layer 136 can have a mesh structure in order to shield the electromagnetic waves emitted by the display apparatus. The conductive layer 136 can be made of Cu, Ag, Al, Ni, and Au.

The chromatic layer 138 can include a dye or a pigment that can selectively absorb light of a specific wavelength in a visible ray region. The dye or pigment can shield unnecessary light around a wavelength of about 585 nm emitted when neon is excited or by near infrared rays. For example, a cyanine-based compound, a squarylium-based compound, an azomethine-based compound, a kisantine-based compound, an oxonol-based compound, and an azo-based compound can be used as the dye or pigment. The kind or density of the dye or pigment can be determined by the absorbing wavelength and the absorbing coefficient of the dye or pigment, the color of a transparent layer, and the transmission characteristic and the transmittance of the film filter.

The reflection preventing layer 142 can perform an antireflective (AR) function and a low reflective (LR) function that suppress the surface reflection of a screen using light interference. The reflection preventing layer 142 can be formed by a dry coating method in which an inorganic inductor is laminated by deposition or sputtering or a wet coating method in which an organic material is coated in order to prevent reflection. On the other hand, the reflection preventing layer 142 can be formed of a plurality of layers having different refractive indexes. On the other hand, the reflection preventing layer 142 can be formed by coating a single layer made of a material having a low refractive index in order to perform the LR function. The reflection preventing layer 142 can be made of an organic material such as fluoride resin or an inorganic material such as SiO₂ and ITO.

In the film filter used for the display apparatus, effective impact absorbance can vary with required impact absorbing ability, however, in a range of about 25% to 40% is preferred. When the above-described film filters according to the present embodiments are applied to the display apparatus, desired impact absorbing ability can be easily obtained.

FIGS. 7A and 7B are schematic sectional views of the display apparatus according to the present invention.

Referring to FIG. 7A, a plasma display apparatus according to the present embodiment includes a display panel 200, the impact absorbing structure 110 laminated on one surface of the panel 200, and the functional layer 130 laminated on one surface of the impact absorbing structure 110. The impact absorbing structure 110 is provided between the panel 200 and the functional layer 130.

The impact absorbing structure 110 can have the structures of the impact absorbing layers included in the film filters described with reference to FIGS. 1 to 5B other than the structure of the impact absorbing layer included in the film filter described with reference to FIG. 6. Since the functional layer 130 is actually the same as the functional layer included in the film filter described with reference to FIG. 6, detailed description thereof will be omitted.

In addition, as illustrated in FIG. 7B, the display apparatus according to the present embodiment can include the display panel 200, the impact absorbing structure 110 provided on one surface of the panel 200, and the functional layer 130 provided between the panel 200 and the impact absorbing structure 110. In the display apparatus having such a structure, since the impact absorbing structure 110 is provided on the uppermost layer on one surface of the display panel 200, it is possible to prevent the external impact energy from being transmitted to the functional layer 130 and the panel 200.

The above-described display panel 200 can be one of a plasma display panel (PDP), an organic light emitting display (OLED) panel, and a liquid crystal display (LCD) panel. Since the above-described display panels are well known, detailed description thereof will be omitted.

Meanwhile, the film filters according to the above-described embodiments can be attached to the display panel after being additionally manufactured. On the other hand, the above-described film filters can be directly formed on the front surface glass substrate of the display panel.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A film filter, comprising:
a first layer including ribs and a plurality of openings partitioned by the ribs and having first hardness; and
a second layer including a plurality of cells formed in the openings and having second hardness lower than the first hardness.

2. The film filter as claimed in claim 1, wherein a height of the ribs, a distance between adjacent ribs, and a width of the ribs are set to primarily absorb and disperse external impact and to transmit to the second layer.

3. The film filter as claimed in claim 2, wherein the first layer comprises a condensation ratio of 5% to 30% in a reversible range.

4. The film filter as claimed in claim 1, wherein hardness of the second layer is lower than the hardness of the first layer by 23% to 45%.

5. The film filter as claimed in claim 1, wherein at least one surface of a side surface of the second layer inclines based on a thickness direction of the first layer.

6. The film filter as claimed in claim 1, wherein the openings are polygonal.

7. The film filter as claimed in claim 6, wherein one end of each of the openings is closed by the first layer.

8. The film filter as claimed in claim 1, further comprising a first interposing layer provided on one surface having a structure in which the second layer is inserted into the openings.

9. The film filter as claimed in claim 8, further comprising a second interposing layer provided on the other surface that faces the one surface having the structure in which the second layer is inserted into the openings.

10. The film filter as claimed in claim 8, wherein the first interposing layer is made of poly ethylene terephthalate or poly carbonate.

11. The film filter as claimed in claim 1, wherein the first layer is made of at least one selected from the group consisting of poly ethylene terephthalate, poly carbonate, ethylene vinyl acetate (EVA), and urethane based.

12. The film filter as claimed in claim 11, wherein the first layer is colored by a dye or a pigment.

13. The film filter as claimed in claim 1, wherein the second layer is made of at least one selected from the group consisting of a polymer containing ethylene vinyl acetate (EVA), a copolymer of styrene and ethylene (styrene ethylene butadiene styrene (SEBS)), silicon gel, and highly bridged polyurethane based.

14. The film filter as claimed in claim 1,
wherein the first layer is made of ethylene vinyl acetate (EVA) containing vinyl acetate no more than 20 wt %, and
wherein the second layer is made of ethylene vinyl acetate (EVA) containing vinyl acetate no less than 40 wt %.

15. The film filter as claimed in claim 1,
wherein the first layer is made of ethylene vinyl acetate (EVA) containing vinyl acetate no more than 20 wt %, and
wherein the second layer is made of silicon based.

16. The film filter as claimed in claim 1, further comprising at least one functional layer for shielding electromagnetic waves, near infrared rays, and neon light, for correcting colors, and for preventing reflection of external light.

17. A display apparatus, comprising:
a display panel; and
a film filter provided on one surface of the display panel,
wherein the film filter comprises:
a first layer including ribs and a plurality of openings partitioned off by the ribs and having first hardness; and
a second layer including a plurality of cells inserted into the openings and having second hardness lower than the first hardness.

18. The display apparatus as claimed in claim 17,
wherein the first layer has a condensation ratio of 5% to 30% in a reversible range, and
wherein a height of the ribs, a distance between adjacent ribs, and a width of the ribs are set so that external shock can be primarily absorbed and dispersed and can be transmitted to the second layer.

19. The display apparatus as claimed in claim 17, wherein the film filter further comprises a first interposing layer provided on one surface having a structure in which the second layer is inserted into the openings.

20. The display apparatus as claimed in claim 17, wherein the display panel is one of a plasma display panel (PDP), an organic light emitting display (OLED) panel, and a liquid crystal display (LCD) panel.
